(19) United States
(12) Patent Application Publication
(10) Pub. No.: US 2020/0029400 A1
(43) Pub. Date: Jan. 23, 2020

(54) DOMESTIC APPLIANCE DEVICE AND METHOD FOR OPERATING A DOMESTIC APPLIANCE DEVICE

(71) Applicant: BSH Hausgeräte GmbH, Munich (DE)

(72) Inventors: Arturo Acevedo Simon, Zaragoza (ES); Julio Lafuente Ureta, Zaragoza (ES); Ignacio Millan Serrano, Zaragoza (ES); Diego Puyal Puente, Zaragoza (ES)

(21) Appl. No.: 16/485,929

(22) PCT Filed: Mar. 12, 2018
(86) PCT No.: PCT/IB2018/051615

§ 371 Date: Aug. 14, 2019

(30) Foreign Application Priority Data
Mar. 30, 2017 (ES) P201730508

(51) Int. Cl. H05B 6/12; H02M 1/32; H02J 7/00

(52) U.S. Cl. CPC H05B 6/1209; H02M 7/06; H02J 7/0063; H02M 1/32

(57) ABSTRACT

A household appliance device, in particular cooking appliance device, includes an energy storage unit and a discharge unit which is configured to discharge in a discharging operating mode the energy storage unit at least partially in an at least essentially linear manner.

The invention relates to a household appliance device according to the preamble of claim 1 and a method for operating a household appliance device as claimed in claim 11.

Cooking appliances, in particular induction cooking appliances, are known from the prior art which have at least one main switching unit to supply induction heating elements with a supply voltage through actuation of a main energy supply, and an energy storage unit, in particular a bus capacitor, which is provided in particular for signal smoothing through the charging of an energy storage unit with a charge potential. In an inactive status of the main switching unit, for example prior to switching operation and/or in particular during pulsed operation, the energy storage unit is insufficiently discharged without adjusted discharging. A voltage jump is thereby generated in each charging process for an activation of the switching unit. In addition, a charging current can generate an acoustic noise, disruptive in particular during pulsed operation, as a result of which a switching functionality and consequently operating convenience are degraded.

The object of the invention is in particular to provide a generic device with improved properties in respect of a switching functionality. According to the invention, the problem is solved by the features of claims 1 and 11, while advantageous embodiments and developments of the invention can be derived from the subclaims.

The invention is based on a household appliance device, in particular a cooking appliance device, with at least one discharge unit which is provided, in at least one discharging operating mode, to discharge at least partially at least one energy storage unit.

It is recommended that in the discharging operating mode the discharge unit is provided for an at least essentially linear discharging of the energy storage unit. A functionality of, in particular, a cooking appliance device embodied as an induction cooking appliance, in particular can thereby be improved in respect of a switching process during pulsed heating operation. An improved, in particular uniform, discharging of the energy storage unit can further in particular be achieved, by which the generation of noise can advantageously be reduced, in particular during a switching process for pulsed operation of a household appliance device. Operating convenience can thereby be enhanced, as well as production costs and/or production effort advantageously reduced.

In this connection a “household appliance device” should in particular be understood to mean at least a part, in particular a subassembly of a household appliance, in particular a cooking appliance, preferably a cooktop and particularly preferably an induction cooktop. The household appliance device can also in particular comprise the entire household appliance, the entire cooking appliance, preferably the entire cooktop and particularly preferably the entire induction cooktop. In particular, the household appliance device can further comprise a control unit, an inverter and/or at least one heating element, in particular at least one inductor. In this connection an “energy storage unit” should in particular be understood to mean a unit which is provided to store in particular electrical energy, for the generation of an electrical voltage and/or an electrical current for application to main switch contacts, in particular for actuation of a main switching unit, in particular at least temporarily. In particular, the energy storage unit is formed by at least one electrical capacitance, in particular at least one capacitor. A “discharge unit” should in particular be understood to mean a unit which is electrically connected in particular to the energy storage element and in particular in a discharging operating mode is provided, in particular to discharge at least partially, preferably completely in particular electrical energy stored by the energy storage element, in particular a charge potential present at the energy storage element, and in particular to absorb a discharge current from the energy storage unit by means of a flow that can be switched by means of a main switching unit and preferably to conduct it to at least one consumer electrically connected to the electrical main switching unit, in particular an induction heating element. A “main switching unit” should in particular be understood to mean a unit with at least one switching element embodied as a power switching element which is provided, in at least one switching status, to switch, in particular periodically, a mean current of at least 0.5 A, in particular at least 1 A, advantageously at least 4 A, preferably at least 10 A. In particular, the power switching element is suitable to carry the mean current for a duration of more than 10 seconds, in particular more than 1 minute, advantageously more than 10 minutes, preferably without defect. The power switching element is advantageously embodied as a semiconductor component, in particular as a transistor, advantageously as an IGBT, alternatively as a MOSFET, and/or as a transistor group. In particular, the power switching element is provided to connect at least one power component, in particular at least one inductor, to the main energy supply. In particular, the power switching element provided to switch a current of the inductor, which in the operating mode is provided to draw a power level of at least 100 W, in particular at least 500 W, advantageously at least 1000 W, preferably at least 2000 W, from the main energy supply, with a frequency of at least 1 kHz, in particular at least 10 kHz, advantageously at least 50 kHz. A “switching element” should in particular be understood to mean a component which is provided, depending upon at least one signal, in particular an electrical voltage present at main switch contacts, to make and/or break at least one electrically conductive connection between at least two power contacts. A “discharge parameter” should in particular be understood to mean a parameter, in particular of a discharged component, in particular of the energy storage unit, which in particular is correlated with the discharging of the energy storage unit. In particular, a discharge parameter can be correlated with a discharge current, with a discharge voltage and/or a charge potential, and can in particular can have a magnitude which is advantageously embodied proportionally to the discharge current, the discharge voltage and/or the charge potential.

A “discharging operating mode” should in particular be understood to mean an operating mode, in particular of the discharge unit and the energy storage unit, in which the discharge unit at least reduces a charge potential of the energy storage unit, in particular by means of a discharge current. In particular, a discharging operating mode can be initiated by means of a switching element, in particular by means of a main switching element of the main switching unit. The phrase “at least partially discharge” should in particular be understood to mean that a discharge unit reduces a charge potential present at an object storing electrical energy, in particular of a capacitor with an energy storage unit, by means of a flow of discharge current during a discharging process, in particular in the discharging operating mode, in such a way that the electrical potential at the end of the discharging process has a magnitude which corresponds to at most 50%, preferably at most 40%, advantageously at most 30%, particularly preferably at most 20%, and particularly advantageously at most 10%, of a magnitude of the potential at the start of the discharging process. In particular, the energy storage unit is fully discharged at the end of the discharging process, wherein the potential at the end of the discharging process corresponds to 0% of the magnitude of the potential at the start of the discharging process. An “at least essentially linear discharging” should in particular be understood to mean a process in the discharging operating mode of the cooking appliance device, in which the energy storage unit releases at least temporarily stored energy, in particular the charge potential, to a discharge unit, over a discharge time, by means of an essentially constant discharge current, wherein the charge potential in particular has an essentially constant decrease, so that a signal, which over the discharge time is proportional to the magnitude of the charge potential of the energy storage unit, has a negative, in particular constant slope. The discharging preferably takes place completely, in particular until the potential of the energy storage unit amounts to 0 volts. In particular, the magnitude of the discharge current in the discharging operating mode is at least essentially constant. In this connection, “at least essentially constant” should in particular be understood to mean that the magnitude of the discharge current deviates from a magnitude of the discharge current averaged out over the discharge time by at most 15%, preferably by at most 10% and particularly preferably by at most 5%. The word “provided” should in particular be understood to mean specially programmed, designed and/or equipped. That an object is provided for a particular function should in particular be taken to mean that the object fulfills and/or performs this particular function in at least one usage and/or operating status.

It is additionally recommended that the discharge unit has at least one main switching unit connected in series with the energy storage unit and at least one adjustment unit assigned to the main switching unit, which is provided to influence at least one discharge parameter in the discharging operating mode. An “adjustment unit” should in particular be understood to mean a unit advantageously connected, in particular electrically, to the main switching unit, which is provided to influence a discharge parameter, in particular the discharge parameter of the energy storage unit. In particular, the adjustment unit is embodied as an electrical circuit and is electrically connected in particular to the main switching unit and/or in particular to the energy storage unit. In particular, the adjustment unit is provided to keep the discharge parameter, in particular a magnitude of the discharge parameter, in particular at least essentially constant. That an object, in particular the adjustment unit, is provided, “to influence” a parameter, in particular the discharge parameter, should in this connection in particular be understood to mean that in the case of the absence and/or inactivity of the object, in particular of the adjustment unit, the discharge parameter has and/or assumes a different status, a different course, and/or in particular a different quantity than in the case of the presence and/or activity of the object, in particular of the adjustment unit. In particular, the adjustment unit is provided at least largely to reduce a change in the discharge parameter. A particularly efficient discharging of the energy storage unit can thereby be achieved, by means of which a functionality of the cooking appliance device and advantageously operating convenience can be improved.

It is further recommended that the discharge parameter is correlated with a discharge current. In particular, the discharge parameter is proportional to the discharge current of the energy storage unit, which can advantageously be simply measured in particular by means of a current measuring element, in particular a measurement diode and/or an electrical resistance. In particular, the discharge current correlates with the potential of the energy storage unit. Improved control and advantageously simplified regulation of the discharge unit can thereby in particular be achieved.

In one preferred embodiment of the invention it is recommended that the adjustment unit is arranged between a control connection and a power connection of the main switching unit. In particular, the main switching unit has at least two power connections, in particular a first power connection and a second power connection, wherein the control connection is provided for controlling the main switching unit, in particular temporarily to embody, in particular to actuate, a conductive connection between the first power connection and the second power connection, depending upon a potential present at the control connection. In particular, the adjustment unit is electrically connected to a control connection and a power connection of the main switching unit. In particular for controlling the main switching unit the adjustment unit is connected to the control connection and for measurement of the discharge parameter to a power connection. A space-saving adjustment unit and improved control of a discharging of the energy storage unit can thereby be achieved.

In particular, an adjustment unit can be controlled by means of an activated and/or external control and/or regulation unit and adjustment regulated. In the preferred embodiment of the invention it is however recommended that the adjustment unit is embodied to be self-controlling. In particular, advantageously simple, cost-effective and secure control can hereby be achieved. That at least one adjustment unit is embodied to be “self-controlling” should in particular be understood to mean that in at least one operating mode, in particular a discharging operating mode the adjustment unit changes its status automatically and autonomously, in particular depending upon an in particular current discharge parameter, in particular a discharge current and/or a discharge voltage of the at least one main switching unit. In particular, the at least one adjustment unit is free of an in particular direct connection to an external control unit.

For a particularly efficient adjustment of the discharge parameter and an advantageously improved discharging of an energy storage unit it is recommended that the adjustment unit comprises at least one adjustment switching unit. In particular, the adjustment switching unit comprises at least one adjustment switching element embodied as a MOSFET, by means of which in particular a controllable and advantageously improved influencing of the discharge parameter can be achieved.

For particularly efficient adjustment of the discharge parameter it is further recommended that a control connection of the adjustment switching unit is connected to a line connection of the main switching unit, in particular indirectly via at least one resistance. In particular, influencing of the discharge parameter, in particular of the discharge current, by means of the adjustment switching unit, in particular the adjustment unit, can be controlled at the control connection of the adjustment switching unit by means of a measured control signal, in particular of the discharge parameter. An improved and in particular more rapid influencing of the discharge parameter can thereby be achieved.

It is additionally recommended that the main switching unit is embodied as an inverter switch, wherein the main switching unit has a switching time of at most 10 ms. The inverter is preferably provided to provide and/or to generate an oscillating electrical current, preferably with a frequency of at least 1 kHz, in particular of at least 10 kHz and advantageously of at least 20 kHz, in particular for operation of the at least one induction heating element. The inverter advantageously comprises the main switching unit, in particular the power switching element, which is provided for actuation of the discharge parameter. A “switching time” should here in particular be understood to mean the duration of an activation, in particular switching, in particular controlled by means of switch driver unit, of the main switching unit embodied as an inverter, which in particular in pulsed operation of the household appliance device, in particular of the induction heating unit, corresponds to the length of a pulse of the electrical energy for supplying the induction heating unit. In particular, a switching time of preferably less than 10 ms, advantageously less than 5 ms and preferably less than 3 ms can be achieved. Short switching times can thereby in particular be achieved and an advantageously improved discharging of the discharge unit achieved, by means of which operating convenience can advantageously be enhanced as a result of noise reduction.

In order advantageously to improve a production process and consequently in particular to reduce production costs, in a preferred embodiment of the invention it is recommended that the discharge unit is embodied at least partially using SMD design, in particular surface-mounting-device design, in particular on a PCB. In particular, the main switching unit can advantageously be embodied as a surface-mounting D2Pak MOSFET and at least one measuring element of the measuring unit, in particular the measuring unit introduced above, advantageously embodied as an individual SMD resistance. In particular, all further components of the discharge unit and advantageously also the energy storage unit can be embodied using SMD design.

In addition a method for operating a household appliance device is recommended, in particular with at least one discharge unit, which is provided, in at least one discharging operating mode, at least partially to discharge at least one energy storage unit, wherein in at least one discharging operating mode, an energy storage unit is at least essentially linearly discharged. In particular the functionality of a cooking appliance device, in particular one embodied as an induction cooking appliance, can thereby be improved with respect to a switching process. In particular an improved, in particular uniform discharging of the energy storage unit can further be achieved, by which the generation of noise is advantageously reduced, in particular during the switching-on process of a household appliance device. Operating convenience can thereby be enhanced, as well as production costs and production effort advantageously reduced.

Further advantages emerge from the following description of the drawings. The drawings show an exemplary embodiment of the invention. The drawings, the description and the claims contain numerous features in combination. The person skilled in the art will expediently also consider the features individually, and put them together into sensible further combinations.

Wherein:

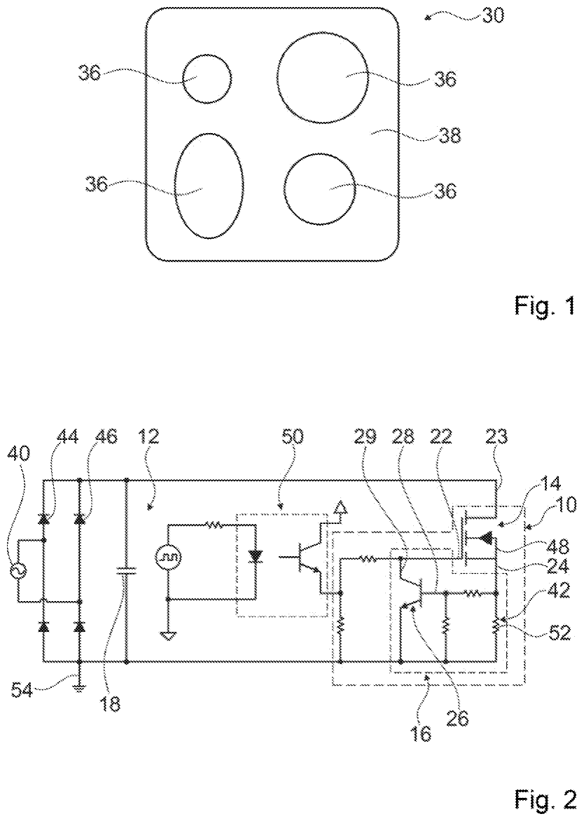

FIG. 1 shows a household appliance embodied as a cooktop with a household appliance device, in a top view,

FIG. 2 shows a circuit diagram of the household appliance device and

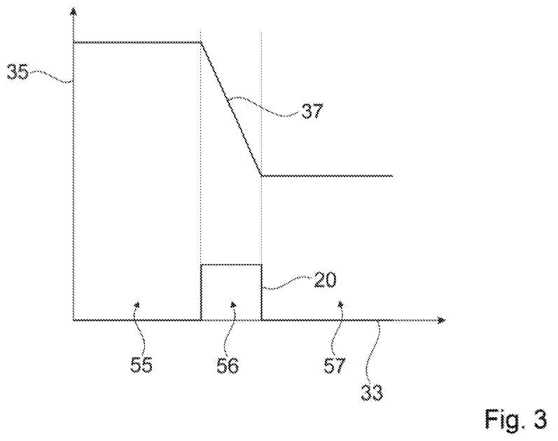

FIG. 3 shows a schematic diagram of a signal of a charge potential and a signal of a discharge current of an energy storage unit of the household appliance device.

FIG. 1 shows household appliance 30 embodied as an induction cooktop with inductors 36, which are arranged under a cooktop hotplate 38. The household appliance 30 has a household appliance device embodied as a cooking appliance device.

FIG. 2 shows a circuit diagram of the household appliance device. The household appliance device has a connection to a main energy supply 40. The main energy supply 40 is provided to deliver an alternating voltage. The main energy supply 40 is provided to deliver a supply voltage. An amplitude of the supply voltage amounts to maximum 390 volts. In the present case, an amplitude of the supply voltage amounts to 280 volts.

The household appliance device has an energy storage unit 12. A first connection of the energy storage unit 12 is connected to a first connection of the main energy supply 40 via a first blocking diode 44. The first connection of the energy storage unit 12 is connected to a second connection of the main energy supply 40 via a second blocking diode 46. A second connection of the energy storage unit 12 is connected to a reference potential 54 of the household appliance device. The reference potential 54 is embodied as ground potential. The main energy supply 40 is provided to charge the energy storage unit 12 via the first connection of the energy storage unit 12. A charge potential 37 is present between the first connection and the second connection of the energy storage unit 12.

The energy storage unit 12 has at least one energy storage element 18. The energy storage element 18 is embodied as a capacitor. The energy storage element 18 has a capacitance between 1 μF and 1 mF. In the present case, the energy storage element 18 has a capacitance of 6.6 μF. The blocking diodes 44, 46 are provided to specify a direction of flow of a charging current from the main energy supply 40. The blocking diodes 44, 46 are provided to limit a charging current from the main energy supply 40. The blocking diodes 44, 46 are provided to prevent a direction of flow of a discharge current 20 to the main energy supply 40. The blocking diodes 44, 46 prevent a discharging of the energy storage element 18 via the main energy supply 40. The energy storage element 18 is embodied as a bus capacitor.

The household appliance device has a discharge unit 10. The discharge unit 10 is electrically arranged between the reference potential 54 and a potential of the alternating voltage of the main energy supply 40. In a discharging operating mode the discharge unit 10 is provided to discharge the energy storage unit 12. In a discharging operating mode the discharge unit 10 is provided to fully discharge the energy storage unit 12. In the case of a switching-on process and in particular in pulsed operation of the household appliance device, a full discharging of the energy storage unit 12 prevents further charging in a switching-on process and in particular upon activation of a pulse generating a voltage jump, wherein a charging current generates an acoustic noise upon each switching of a pulse. The discharge unit 10 is completely embodied using surface-mounting-device design. The discharge unit 10 is arranged, in particular soldered, on a PCB. It is also conceivable to manufacture the household appliance device completely using surface-mounting-device design.

The discharge unit 10 has at least one main switching unit 14. The main switching unit 14 is electrically connected to the main energy supply 40. The main switching unit 14 is provided to discharge the energy storage unit 12. The main switching unit 14 is connected in series with the energy storage unit 12. The main switching unit 14 is embodied as an inverter switch. A switching time of the main switching unit 14 amounts to at most 10 ms. The switching time of the main switching unit 14 amounts in the present case to 2.7 ms. The main switching unit 14 comprises at least one power switching element 48.

The power switching element 48 is embodied as a MOSFET. The power switching element 48 is embodied as a surface-mounting component. The power switching element 48 is embodied as a semiconductor component, in particular as a D2PAK. The power switching element 48 has a first power connection 23. The first power connection 23 is electrically connected to the first connection of the energy storage unit 12. The power switching element 48 has a second power connection 24. The power switching element 48 has a control connection 22. In an operating mode the control connection 22 is provided to form an electrical connection between the first power connection 23 and the second power connection 24, depending upon a voltage present at the control connection 22. The control connection 22 is provided to actuate the power switching element 48.

The control connection 22 is electrically connected to a switch driver unit 50. The switch driver unit 50 is embodied as an optocoupler. The switch driver unit 50 provides an electrical voltage for actuation of the main switching unit 14. The switch driver unit 50 provides a control potential for actuation of the main switching unit 14. The switch driver unit 50 provides a periodic signal for actuation of the main switching unit 14. The switch driver unit 50 delivers an alternating voltage for the control connection 22 of the main switching unit 14. If an electrical potential, in particular a control potential, is present at the control connection 22, the first power connection 23 and the second power connection 24 are electrically connected. The switch driver unit 50 is provided to periodically actuate the main switching unit 14.

In the operating mode in which the first power connection 23 and the second power connection 24 are electrically connected, the discharge current 20 flows from the energy storage unit 12 via the first connection of the energy storage unit 12, through the first power connection 23, through the main switching unit 14 to the second power connection 24. In this operating mode, the main switching unit 14 is provided to discharge the energy storage unit 12. In this operating mode, the discharge unit 10 is provided to discharge the energy storage unit 12. The operating mode is embodied as the discharging operating mode. In the discharging operating mode the charge potential 37 decreases with the discharge current 20 flowing through the main switching unit 14 via a discharge voltage. In the discharging operating mode the discharge unit 10 is provided for a linear discharging of the energy storage unit 12.

The discharge unit 10 has an adjustment unit 16. The adjustment unit 16 is assigned to the main switching unit 14. The adjustment unit 16 is arranged between the control connection 22 and the power connection 24 of the main switching unit 14. The adjustment unit 16 is electrically connected to the control connection 22 of the main switching unit 14. The adjustment unit 16 is electrically connected to the second power connection 24 of the main switching unit 14. The adjustment unit 16 is additionally connected to the reference potential 54, in particular to the ground potential. In the discharging operating mode the adjustment unit 16 is provided to influence a discharge parameter. In the discharging operating mode the adjustment unit 16 is provided to influence the discharge current 20.

The adjustment unit 16 has at least one adjustment switching unit 26. The adjustment switching unit 26 has at least one switching element embodied as a MOSFET. The adjustment switching unit 26 has a control connection 28. The control connection 28 is electrically connected to the second power connection 24 of the main switching unit 14. The control connection 28 is electrically connected to the second power connection 24 of the power switching element 48. The adjustment switching unit 26 has a first power connection 29. The first power connection 29 is connected to the control connection 22 of the main switching unit 14. The first power connection 29 is electrically connected to the control connection 22 of the power switching element 48.

The adjustment unit 16 additionally has a control unit 42. The control unit 42 has an electrical resistance 52. The electrical resistance has a magnitude of between 0.1Ω and 10Ω. In the present case, the electrical resistance of the control unit 42 amounts to 1.5Ω. A first contact of the control unit 42 is electrically connected to the second power connection 24 of the main switching unit 14. The first contact of the control unit 42 is connected to the control connection 28 of the adjustment switching unit 26. A second contact of the control unit 42 is connected to the reference potential 54.

The adjustment unit 16 is embodied to be self-controlling. In the discharging operating mode the main switching unit 14 is actuated. The discharge current 20 flows from the energy storage unit 12 via the main switching unit 14 into the control unit 42. The charge potential 37 of the energy storage unit 12 decreases proportionally to the discharge current 20. The discharge voltage at the electrical resistance 52 of the control unit 42 falls. The discharge voltage is present at the control connection 28 of the adjustment switching unit 26. The first power connection 29 of the adjustment switching unit 26 is electrically connected to a second power connection of the adjustment switching unit 26. An electrical signal, in particular an electrical alternating voltage from the switch driver unit 50 drops partially via the adjustment unit 16 to the reference potential 54 ab. The electrical voltage, in particular the control voltage at the control connection 22 of the main switching element is thereby changed. The electrical connection, in particular an electrical contact of the power connections 23, 24 of the main switching unit 14 is changed, so that the discharge current 20 is influenced. In the control unit 42 a lower discharge voltage drops, as a result of which the control voltage at the control connection 22 of the main switching unit 14 is changed, and a changed discharge current 20 flows into the control unit 42.

FIG. 3 shows signals of the discharge current 20 and of the charge potential 37 of a discharging of the energy storage unit 12 in a schematic representation. The schematic representation shows an ordinate axis 35, which is represented as a value axis. The ordinate axis 35 shows two ordinate ranges, in particular a lower ordinate range, which shows a signal of the discharge current 20, and an upper ordinate range, which shows a signal of the charge potential 37. The representation also shows an abscissas axis 33, which is shown as a time axis. The abscissas axis 33 can be divided into three areas 55, 56, 57, in particular a first area 55, which shows a charged status of the energy storage unit 12, a second area 56, which shows the discharging operating mode, and a third area 57, which shows a discharged status of the energy storage unit 12.

The charge potential 37 is constant in the first area 55 and amounts to at most 390 V. The discharge current 20 in the first area 55 is 0 A.

In the discharging operating mode the discharge unit 10 influences the discharging in such a way that in the second area 56 the charge potential 37 decreases linearly. In the second area 56, the slope of the charge potential 37 is negatively embodied. In the second area 56 the rise in the charge potential 37 has a magnitude of at most 144 kV/μs. In the second area 56 the discharge current 20 is constant and amounts in the present case to 0.953 A. In the second area 56, a temperature of the main switching unit 14 is almost constant, in particular an increase in temperature in the discharging operating mode amounts to at most 10%.

In the third area 57 the charge potential 37 is constant and amounts to 0 volts. In the third area 57 the energy storage unit 12 is fully discharged. In the third area 57 the discharge current 20 accordingly amounts to 0 A.

### REFERENCE CHARACTERS

10 Discharge unit
12 Energy storage unit
14 Main switching unit
16 Adjustment unit
18 Energy storage element
20 Discharge current
22 Control connection
23 Power connection
24 Power connection
26 Adjustment switching unit
28 Control connection
29 Power connection
30 Household appliance
33 Abscissas axis
35 Ordinate axis
36 Inductor
37 Charge potential
38 Cooktop hotplate
40 Main energy supply
42 Control unit
44 Blocking diode
46 Blocking diode
48 Power switching element
50 Switch driver unit
52 Electrical resistance
54 Reference potential
55 Area
56 Area
57 Area

1-11. (canceled)

12. A household appliance device, in particular cooking appliance device, comprising:
an energy storage unit; and
a discharge unit configured to discharge in a discharging operating mode the energy storage unit at least partially in an at least essentially linear manner.

13. The household appliance device of claim 12, wherein the discharge unit includes a main switching unit connected in series with the energy storage unit, and an adjustment unit connected to the main switching unit and configured to influence a discharge parameter in the discharging operating mode.

14. The household appliance device of claim 13, wherein the discharge parameter is correlated with a discharge current.

15. The household appliance device of claim 13, wherein the adjustment unit is arranged between a control connection and a power connection of the main switching unit.

16. The household appliance device of claim 13, wherein the adjustment unit is embodied to be self-controlling.

17. The household appliance device of claim 13, wherein the adjustment unit comprises an adjustment switching unit.

18. The household appliance device of claim 17, wherein the adjustment switching unit includes a control connection, which is connected with a power connection of the main switching unit.

19. The household appliance device of claim 13, wherein the main switching unit is embodied as an inverter switch and has a switching time of at most 10 ms.

20. The household appliance device of claim 12, wherein the discharge unit is embodied at least partially using SMD design.

21. A household appliance, in particular cooking appliance, comprising a household appliance device, said household appliance device comprising an energy storage unit, and a discharge unit configured to discharge in a discharging operating mode the energy storage unit at least partially in an at least essentially linear manner

22. A method for operating a household appliance device, comprising at least essentially linearly discharging an energy storage unit in a discharging operating mode by a discharge unit.

23. The method of claim 22, further comprising:
connecting a main switching unit of the discharge unit in series with the energy storage unit; and
connecting an adjustment unit of the discharge unit to the main switching unit and configured to influence a discharge parameter in the discharging operating mode.

24. The method of claim 23, wherein the discharge parameter is correlated with a discharge current.

25. The method of claim 23, further comprising arranging the adjustment unit between a control connection and a power connection of the main switching unit.

26. The method of claim 23, wherein the adjustment unit is embodied to be self-controlling.

27. The method of claim 23, wherein the adjustment unit comprises an adjustment switching unit.

28. The method of claim 27, further comprising connecting a control connection of the adjustment switching unit with a power connection of the main switching unit.

29. The method of claim 23, wherein the main switching unit is embodied as an inverter switch and has a switching time of at most 10 ms.

30. The method of claim 22, wherein the discharge unit is embodied at least partially using SMD design.
